(19) United States
(12) Patent Application Publication
(10) Pub. No.: US 2018/0013816 A1
(43) Pub. Date: Jan. 11, 2018

(54) Method and Apparatus for On Demand Mobile Data Transfer

(71) Applicant: Saeid Safavi, San Diego, CA (US)

(72) Inventor: Saeid Safavi, San Diego, CA (US)

(21) Appl. No.: 15/639,673

(22) Filed: Jun. 30, 2017

Related U.S. Application Data
(60) Provisional application No. 62/359,032, filed on Jul. 6, 2016.

(51) Int. Cl. H04L 29/08; G06Q 50/32; G06F 19/00; H04W 84/04; G06F 17/24

(52) U.S. Cl. CPC H04L 67/06; G06Q 50/32; G06F 19/322; G06F 17/243; H04W 84/042

(57) ABSTRACT

Systems and methods for providing user information to an enterprise network of a business or service facility. A user device provides information in a form in response to coming in proximity to a participating enterprise network. In some cases, the enterprise network provides a form to be completed by the user device and returned to the enterprise network. In other cases, the user device already has the desired form and merely responds to the request from the enterprise network for the completed form. Information provided in the form can be stored in the user device or in an external storage, such as in a cloud system or other external storage system.

### CROSS-REFERENCE TO RELATED APPLICATION—CLAIM OF PRIORITY

This application claims the benefit of priority to provisional Application No. 62/359,032 filed Jul. 6, 2016, entitled “Method and Apparatus for On Demand Mobile Data Transfer”, the disclosure of which is incorporated herein by reference in its entirety.

### FIELD

This disclosure relates to wireless data transfer, data storage, printing services, and applications running on mobile devices, and more particularly to providing information that can be communicated, printed, and filed in a business database on an appropriate form, label, etc., in place of providing handwritten forms.

### BACKGROUND

Over past decade, wireless communications network technology has undergone unprecedented evolution from digital 2G voice-based cellular communications systems (e.g. GSM) to multi-service heterogeneous networks that can handle data and high speed multimedia, in addition to voice applications (e.g. 3G cellular and beyond including WCDMA, HSPA, etc.), WiMAX, Wireless Local Area Networks (WLAN) and the future Long Term Evolution (LTE) or 4G cellular. These technologies were initially designed to serve a variety of wireless applications and coverage classes, ranging from WBAN (Wireless Body Area Networks) and WPAN (Wireless Personal Area Networks, e.g. Bluetooth), to WLAN (e.g. WiFi), WMAN (Wireless Metropolitan Area Networks, such as WiMAX), all the way to WWAN (wireless wide area networks such as WCDMA, LTE and LTE-A).

As these new technologies have evolved, the need for integration of various applications and end-to-end services has become increasingly significant. Advances in wireless access technologies, networking, and content delivery have played key roles in enabling such provisioning scenarios. In addition, new service models are constantly evolving, both in the home and in enterprise scenarios, to enhance the user experience, increase revenue, and enable execution of desired tasks with greater efficiency.

As the deployment of various new applications and services becomes increasingly necessary in enterprise scenarios, the existing network infrastructure in various private and public service sectors has started to fall short of the growth in the service requirements. This is particularly true for small businesses that require some form of manual user input or interaction before they can provide their service. This is in part due to computer networks being dedicated to the employees of the service provider, and unavailable to the customer or service user.

For example, in almost all doctors' offices in the United States, information regarding the user has to be manually entered into the system through hand-filled form hard copies. The task of providing and entering such information consumes a significant amount of time, effort and hence overhead cost to the enterprise and the user of the service.

Several similar systems require a user to provide information that is then manually entered by a employee. For example, in the case of the US Post Office (USPS) or other postal and parcel carrier's (e.g. FedEx, UPS, etc.), customers have to manually fill in the forms and/or labels. This is inconvenient and results in delays that are time consuming to the user due to the need to manually provide and enter the address, addressee, and package information into the system. Since this typically occurs while the customer is being served by an employee, such delay causes longer lines and labor for the service provider. Such delays can, at times, result in dissatisfied customers.

Accordingly, there is a need for a platform and methodology to enhance an enterprise's operational efficiency, reduce costs, and significantly improve the user experience.

### SUMMARY

This disclosure introduces a platform and apparatus that facilitates connection of user data from user mobile devices such as phones, tablets, PDAs, etc., to an enterprise network (such as a network administered by a business) for a purpose of providing from users, information desired by the business. The disclosed method and apparatus consists of various embodiments summarized below.

Some embodiments of such a system include at least a processor and a memory residing on user device. The memory stores instructions that, when executed, instruct the processor to identify various pieces of contextual information to be shared between a user device and a destination business device over a radio access technology. A connection between the user device and the destination business device may be re-established for control and management purposes.

An embodiment of a method and apparatus may include algorithms for identifying various pieces of contextual information, including a pre-stored user data to be fetched from memory and stored in various fields of a document, such as e-forms, files, etc.

An embodiment is disclosed in which a computer readable medium has instructions stored therein that identify various pieces of contextual information associated with sending or receiving special data entry tables. Such tables may exist on e-forms in a medical office or address labels in a post office, as well as being used to execute certain tasks, such as printing or data storage for the purpose of generating data that facilitates a service (e.g. medical records of a patient or forms and address labels for a package needs to be mailed).

A cloud server can substitute for, or complement, a “local server computer” to facilitate data transfer and execution of tasks, such as printing or data storage administrated by the service.

In other embodiments, the above architecture can facilitate different types of filling and data transfer services to enhance the user experience, reduce the amount of time consumed by a user and a service provider or an enterprise, resulting in a significant increase in revenue and customer satisfaction.

Many other features and embodiments of the disclosed method and apparatus will be apparent from the accompanying drawings and from the following detailed description.

### BRIEF DESCRIPTION OF DRAWINGS

The accompanying drawings show one or more embodiments; however, the accompanying drawings should not be taken to limit the claimed invention in any way. Various aspects and advantages of the disclosed embodiments will become apparent upon review of the following detailed description and upon reference to the following drawings in which:

FIG. 1 is a diagram illustrating an example of a network interaction architecture for a local file exchange service in a medical office.

FIG. 2 is an example of a sequence of steps by users, networks, and software components to accommodate the service in FIG. 1.

FIG. 3 is a diagram illustrating an example of a network interaction architecture for cloud-based file exchange service in a medical office.

FIG. 4 is an example of a sequence of steps by users, networks and software components to accommodate the service in FIG. 3

FIG. 5 is a diagram illustrating an example of a network interaction architecture for cloud-based file exchange service applied to post office services, or other mail carriers.

FIG. 6 is an example of a sequence of steps by users, networks and software components to accommodate the service in FIG. 5.

FIG. 7 is an example of a software architecture for the on demand local file exchange service.

FIG. 8 is an example of a software architecture for the on demand global (cloud based) file exchange service.

### DETAILED DESCRIPTION

It is believed that the various features described herein will be better understood in conjunction with the drawings provided. The processes, machines, manufactures and any variations thereof described within this disclosure are provided for purposes of illustration. Any specific structural and functional details merely to illustrate the disclosed method and apparatus. Further, the terms and phrases used within this disclosure are not intended to limit the claimed invention, but rather to provide an understandable description of the features described.

The disclosed method and apparatus is applicable to a wide variety of use cases, including various data transfer scenarios associated with various enterprises that involve the transfer of information between a user or customer and the enterprise or business. This may include providing information on a medical office health background form, health insurance form, consent form or other such form used within a medical office, a hospital, or a law office to provide desired information to the business or enterprise. Other cases may include filling address labels at a postal office or other postal service station to make a postal delivery. It will be clear that there are several other examples of businesses that desire information from a user or customer in order to enable or facilitate services desired by the user. Information provided may be used by the business in different ways, including providing information for patient files, printing user records prior to doctors visit, printing address labels, printing and/or storing legal agreements, etc. The main idea is to facilitate an exchange of desired user information between the business and the user. Providing the disclosed system saves time and expense and enhances the user experience.

The platform that enables this data exchange constitutes three (3) major components, namely: “The Infrastructure” which enables network connectivity (e.g. WiFi, 3G, LTE) and includes hardware devices (e.g., User Mobile Device, PC, printer, server) and applicable network functionality performed by one or more of the hardware devices; “The Software” which includes programmable instructions that are designed to run on the infrastructure devices and that are closely associated with the device on which the programmable component is run; and finally “The Algorithms” designed to facilitate the particular services required to complete a “form” and provide the form in an appropriate format to an appropriate end user. For the purposes of this disclosure, the term form includes a wide variety of data structures that conform to a particular protocol, including paper forms that can be printed, electronic forms that conform to a particular data structure comprised of particular fields, etc., and communications protocols that can be used to communicate a related set of data between components of the platform, to mention a few. One such set of data includes medical and/or personal data related to a particular patient within a hospital's patient file.

A) The Infrastructure includes a combination of hardware and networking protocols (e.g., WiFi, Bluetooth, 3G/4G cellular, 60 GHz, etc.) that enables the physical and logical exchange of data between the user device and the business network.

B) The Software includes: (1) User Device Software (UDS) (e.g., Android application, Windows/Mac application, iOS application and/or middleware); (2) Business Network Software (BNS) (e.g., the business application software and software for storage mechanisms such as local data bases, caches, etc.); and (3) Cloud Server Software (CSS) (e.g., (a) software for running massive data bases and parallel processing, such as Hadoop, Cassandra; (b) data retrieval and processing mechanism; such as HIVE, MapReduce, and SQOOP; and (c) an Analytics Engine (AE)).

C) The Algorithms include programmable instructions running on a programmable device. The programmable devices include devices on a business network, cloud, and on a user device. In particular, Algorithms are related to the particular functions necessary to perform services required to complete a form and provide the form in an appropriate format to an appropriate end user. For example, Algorithms may include: (a) scanning a hard copy of a form and converting it to an interactive form that can be filled electronically on a user device or to an electronic editable copy; (b) automatically retrieving user information and autofilling an electronic form; (c) matching the user profile data to the forms required by an associated enterprise service; and (d) performing functions relevant to optimizing the service and that can run on a device within the platform. Algorithms can run on the cloud analytics engine, locally on a user device, or on a business network computer/server.

The following example is provided without loss of generality, and merely as an example of the steps that can be taken to complete a user data sharing process. In this example, a patient is visiting a doctor's office for an appointment. The goal is to electronically fill in all the patient's information, insurance data, consents and acknowledgement forms electronically on the patient's mobile phone, rather than filling hard copies of these forms using a pen and paper. It is assumed that the doctor's office network administrator has the required software component (BNS defined above) already integrated to allow the office to connect the patient's device to the office network and download the appropriate electronic forms (e-forms). The user may already have its application component (UDS component defined above) downloaded to its phone or it might be instructed to do so while in the doctor's office.

Once the UDS mobile app on the user mobile device is downloaded, the UDS and BNS communicate to automatically connect the patient's device to the doctor's network and download the electronic forms. The user can manually fill in all of the information required in each form. Alternatively, the user can fill in the information as part of the UDS. The additional required data, or an already stored portion of it, is fetched from an existing user profile database (e.g. located and stored on user device, through UDS or stored as part of user profile during the registration process with the service, on the cloud through CSS). Then, via an autofill software component as part of UDC, and/or through user's typing on its mobile device, the e-form is filled and upon user confirmation, is sent back to the doctor's network (e.g. a guest network, different from the office employee network) to be stored in the user medical file, or printed for user's hard signature, sent to a doctor's office or hospital, etc. Alternatively, if needed, the user signature/fingerprint may be collected through finger-signing/fingerprinting on the mobile device, and after converting the e-form to a convenient format for storage or printing (e.g. Adobe PDF), the filed form is sent back to the office.

The electronic forms may alternatively be downloaded from the cloud, in which case the patient may not be required to connect to the doctor's office. This can be done first by UDS prompting the user to enter the doctor's information. The UDS then connects the user mobile device to the cloud (e.g., through WiFi hotspot or cellular network). The CSS within the cloud fetches the required forms and sends them back to the user device through internet via an access network, such as WiFi or cellular network. The user may then fill in all the forms manually. Alternatively, the UDS fetches the required data (or part thereof) through an autofill algorithm, and sends the forms back to the doctor's network to be stored in the user medical file, or printed for user signature, etc.

In one embodiment sending the forms back to the doctor's office can be done through wireless connectivity of the user device to the doctor's network, or alternatively in another embodiment though the cloud. The later can be established by the CSS receiving the filled forms from the user (e.g. by the same connectivity link that the user inquired the form), storing in user profile in cloud (optional), and then redirect the filled forms back to the doctor's office though the doctor's office Internet connectivity and the BNS. The filled form(s) can then be stored in the user medical file, or printed for user signature, sent to another doctor's office or hospital, etc.

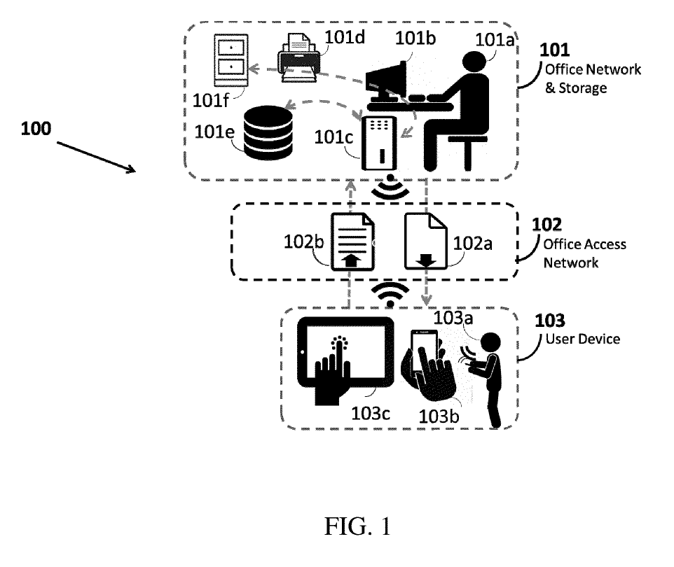

FIG. 1 depicts a simple office scenario, wherein a user device electronically fills in the forms required by a business. In some embodiments, the user device receives a request to provide information in response to the user device being within range to receive signals from an enterprise network associated with the business, such as a WLAN or Wireless Local Area Network. The block 101 illustrates an example of the office network components and its storage mechanisms, consisting of a monitor 101b, a computer 101c, a printer 101d remote from the user device, and filing cabinet 101f. A data storage device is shown in 101e which could be in form of a memory coupled to the computer 101c, wherein the memory comprises instructions that cause the computer 101c to send the data to the memory. In some embodiments, an office administrative personnel 101a interacts with BNS to assist with the data transaction.

In an embodiment, the data storage device 101e may comprise a read only memory (ROM), a random access memory (RAM), a flash memory, an external memory (e.g., a secure digital (SD) card), or any suitable type of memory device as would be appreciated by one of ordinary skill in the art upon viewing this disclosure, or combinations thereof.

In another embodiment, the data storage device 101e may comprise a disk drives, a tape drive, or any suitable type of memory device as would be appreciated by one of ordinary skill in the art upon viewing this disclosure, or combinations thereof.

102 shows a portion of the business wireless network (e.g. WLAN) that is available for the user to connect to, and depicts the blank form 102a downloaded from the network 101, and the filled form 102b, uploaded by the user device system 103, after the form filled in on the user device such as a mobile phone 103b or a tablet 103c. It is noted that all or part of the information required by the form 102a can be filled in by the user 103a or by a component of UDS as described above.

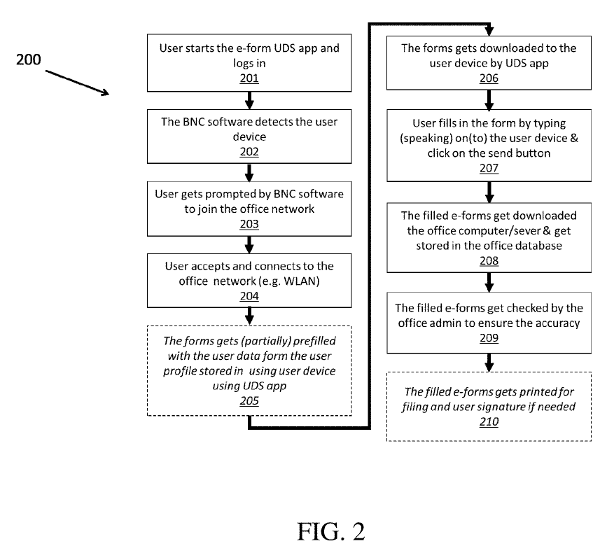

FIG. 2 illustrates the steps required for the connectivity scenario of the FIG. 1 to take place. It is noted that the steps described herein may vary according to the service, user, and network requirements. Accordingly, the mentioned steps are provided solely to illustrate an example of the disclosed method and apparatus. First, the user starts the e-form application on its mobile device and logs in to the app (201). In 202, through signaling between UDS and BNS, the BNS detects the user device. Then in step 203, the BNS signals the UDS to ask the user to join the local area network 102. After user's acceptance the user device 103b, 103c gets connected to the 102 and 101 (204). The step 205, shown in dashed border and italic font, is an optional step, wherein the UDS may fetch a portion of user information (e.g. home address, health information, personal information, etc.) form the user profile stored in his mobile device, by UDS, to later on be used for auto filling the form 102a.

The criterion or set of criteria defining the type of user information being fetched in step 205, may be decided by UDS, e.g. based on the business's related information such as WLAN SSID, user location (which can determine the type of business it is currently visiting), or other contextual information shared by the business network 101, to the user device 101b, or 101c, upon connecting (on-boarding) to the network 102 (strep 204). It is noted that while maintaining user privacy and security, the network 102, is usually a part of the business network that can be shared with an external user (e.g. a guest network). Alternatively, the required personal user information may be fetched from its profile after the form(s) get downloaded into the user device in step 206, in which case, steps 205 and 206 swap their order. In this case UDS can scan the form 102a and based on an internal algorithm decides what type of information should be fetched from the user profile stored on the user device 103b, 103c, to be auto-filled in the form 102a.

In step 206 the form gets downloaded to the user device, while step 207 involves auto-filling of of appropriate fields of the form 102b by the information gathered in step 205, using UDS, should there be an autofill step. The user then gets prompted to fully or partially fill in the form by typing on the blank boxes indicating answers to the e-form questions on its device, depending on whether step 205 has been exercised. Alternatively, if all of the information required by the form is already fetched from the user profile, the form 102, will be entirely filled without any information entering by the user.

It is noted that for any form that requires a user signature, the signature can be collected electronically, through a confirmation by the user, or by using's finger drawing of its signature on the user's device 103b, 103c.

Alternatively, in another embodiment a more secure identity confirmation of the user it its fingerprint, electronically collected by the UDS and incorporated to the filled form 102c, though imprinting on the form, or creation of a separate companion finger print file, sent along with 102c.

In yet another optional step, 209, once the e-filled form is electronically received by the business network 101, an administrative personnel in the office 101a, may download and view the form for accuracy and compliancy.

Finally, in step 210 the filled e-form 102c, will be prepared for storage and stored in the business's records. This storage can be performed electronically on the data storage device 101e through the computer 101c, by the BNS, either automatically, or with the personnel 101a's intervention. Alternatively, if the office only collects hard copies of the user records, or if it is needed in addition to the soft copy, the form can be printed by the BNS and then stored in a file cabinet 101f. It is noted that if a hard signature is needed it can be manually collected form the user after the pint out of the filled form 102c.

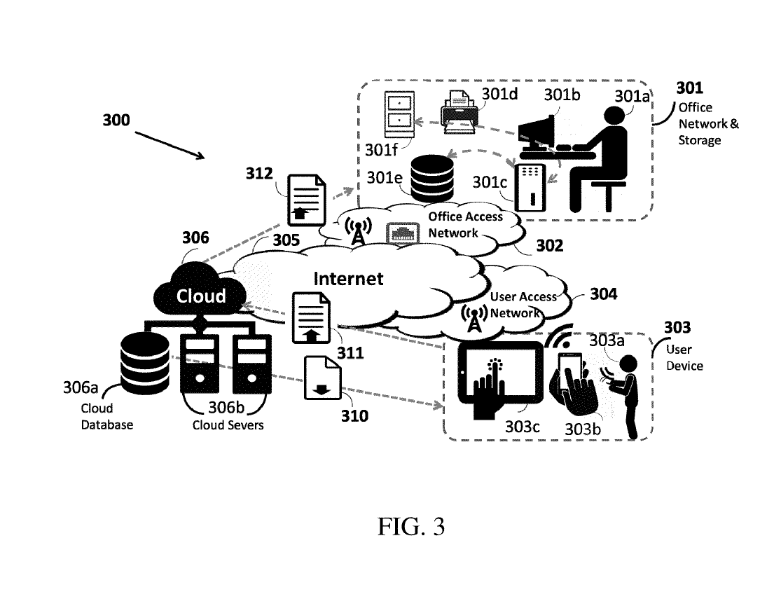

FIG. 3 depicts another example of a scenario such as doctor's office, law office, car rental, etc., wherein a user electronically fills in the forms required by a business, using support from a cloud system which runs the CSS on a required cloud platform to the business office and its network (e.g. WLAN or wireless Local area network). FIG. 3 depicts an example of office network components and associated peripheral and storage devices, including a monitor 301b, a computer 301c, a printer 301d, and filing cabinet 301f. A data storage device is shown in 301e which could be in form of a memory coupled to the processor, wherein the memory comprises instructions that cause the processor to send the data from the computer 301c to the memory. The office administrative personnel interact with BNS for the data transaction.

In an embodiment, the data storage device 301e may comprise a read only memory (ROM), a random access memory (RAM), a flash memory, an external memory (e.g., a secure digital (SD) card), any suitable type of memory device as would be appreciated by one of ordinary skill in the art upon viewing this disclosure, or combinations thereof.

In an embodiment, the data storage device 301e may comprise a disk drives, a tape drive, or any suitable type of memory device as would be appreciated by one of ordinary skill in the art upon viewing this disclosure, or combinations thereof.

A business access network 302 enables connection of the business local network 301 to the Internet. In an embodiment, the access network may be a wired network that using equipment like switches, routers, gateways and wired media technologies such as Ethernet, Coaxial Cables, MoCA (multimedia over cable) connects the business network to the Internet 305.

In another embodiment, access network may be a wireless network that using equipment like switches, routers, gateways and wireless media technologies like WiFi, or Cellular technologies such as GSM, CDMA, HSPA, WCDMA, LTE or LTE-Advanced connects the business network to the Internet 305.

In yet another embodiment the business access network constitutes a hybrid network made from and arbitrary combination of the wired and wireless network technologies.

The user device 303 is coupled through a user's access network 304 that enables connection of the user device 303 to the Internet. In an embodiment, the access network may be a hotspot network that using equipment like switches, routers, gateways and wireless media technologies like WiFi connects the user device to the Internet 305.

In yet another embodiment the business access network may constitute a hybrid network made from and arbitrary combination of the WiFi and Cellular network technologies.

The cloud 306 is an Internet-based computing platform that provides shared processing resources and data to computers and other devices and is deployed on the Internet as an enabler of ubiquitous, on-demand access to a shared pool of configurable computing resources such as storage, networks, servers, applications and services. The cloud components illustrated in FIG. 3, represent a database 306a which in some embodiments is implemented as cloud storage comprising a population of the servers that run and operate in coordination with the CSS software.

In one embodiment, the cloud database stores all the blank e-forms for each business that is registered to the form filling service, and can download them to the user device upon user request. The set of criteria defining which type of form and user information is to be fetched in this step, may be decided by CSS, based on the business's related information such as WLAN SSID, the user location (which can determine the type of business it is currently visiting), or other contextual information that the user device has detected and is communicated through UDS to the CSS.

The form 310, constitutes a blank e-form, or a form which is partially or completely filled in the cloud by the form filling service. In this case, the service stores the user information required for the form upon registration of the user with the form filling service getting rendered at the cloud.

After the user requests to fill the blank e-form 310 for a specific business and selection of the appropriate form in the cloud, the form may be optionally prefilled by the user information from its personal profile in the cloud, and finally is sent and gets downloaded to the user device through interaction between CSS and UDS.

In one embodiment, upon receipt of the e-form, the form gets further analyzed by the UDS in user device and gets partially, or completely filled from the user data stored in the user's local device 303b, 303c.

The e-form 311 indicate the filled form that is completed on user device, directly by the user or automatically from the user device by UDS, or a combination of the two methods. The cloud then sends the filled formv312 back to the business office network for storage, processing or analysis.

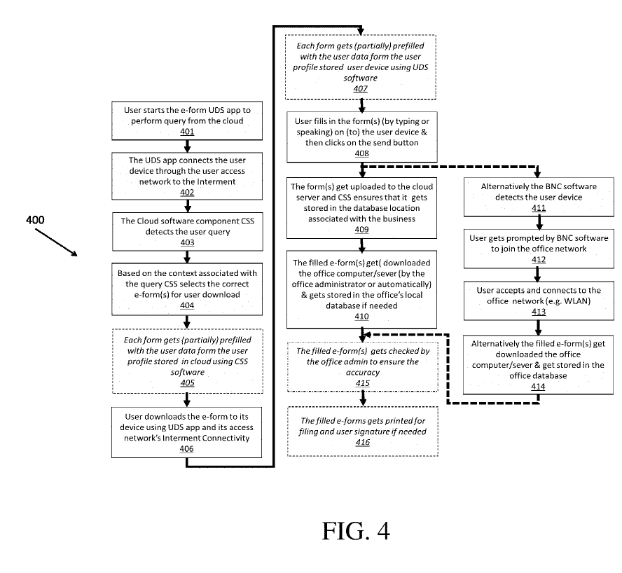

FIG. 4 illustrates the steps required for the connectivity and data exchange scenario of the FIG. 3 to take place. It is noted that the steps described herein may vary according to the service, user, and network requirements. Accordingly, the disclosed steps illustrate one example of steps implemented in accordance with the disclosed method and apparatus. First, the user starts the e-form application on its mobile device and logs in to the app (401). Through the user access network, a signaling between UDS and CSS is established. The CSS then detects the user device's query and gets connected to it, at step 403. Then at step 404, the CSS receives relevant context regarding the required from (e.g. user prompt, user location, your proximity to a network, etc.) and based on this context CSS fetches the appropriate e-form(s) from the cloud database 306a. The step 405, shown in dashed border and italic font, is an optional step, wherein the CSS, UDS or both may fetch portions of user information (e.g. home address, health information, personal information, etc.) form the user profile stored in cloud and/or its mobile device, by UDS, to be used for auto filling the form.

The factor defining which type of user information being fetched in step 405, may be decided by the CSS, based on the business's related information such as WLAN SSID, user location (which can determine the type of business it is currently visiting), or other contextual information shared by the business network 301. Additionally, the required personal user information may be fetched from its profile after the form(s) gets downloaded into the user device in step 406, in which case, a step 407 may follow the step 406. In either case the CSS or UDS can electronically scan the form 310 and based on an internal algorithm decides what type of information should be fetched from the user profile stored on the user device 103b, 103c, to be filled in appropriate locations of the form 310.

In step 406 the e-form gets downloaded the user device, while as discussed, in step 407 involves the auto fill of appropriate fields of the form 310 by the information gathered in step 405, using UDS, should there be a local auto fill step. The user then gets prompted to fully or partially fill in the form by typing on its device, depending on whether steps 405 and/or 407 has been exercised. Alternatively, if all of the information required by the form is already fetched from the user profile, the form 310, will be entirely filled without any information entering by the user.

It is noted that for any forms that require user signature the signature can be collected electronically, through a confirmation by the user, or by user's finger sketching of its signature on the user's device 303b, 303c. Alternatively, a more secure identity confirmation of the user it its fingerprint, electronically collected by the UDS and incorporated to the filled form 311, though imprinting of the form or a companion finger print file, sent along with 311.

In one embodiment, the e-form then gets uploaded to the cloud and through a component of CSS software running on the server 306b it gets stored in a secure location in the database 306a, if needed.

Using CSS, the filled e-form 312 is then sent to the business network, via Internet and gets downloaded to the business network 301 to be stored in the office local database in needed (410)

In another embodiment, after filling the form on user device, the BNS software can connect the user device to the business network and download the form directly through the local area network of the office. This is shown in FIG. 4 by steps 411, through 414.

In yet another optional step, 415, once the e-filled form is electronically received by the business network 101, an administrative personnel in the office 301a, may download and view the form for accuracy and compliancy.

Finally, in step 416 the filled e-form 312 received from the cloud (or from direct link to the office WLAN), will be prepared for storage and stored in the business's records. This storage can be performed electronically on the data storage device 301e through the computer 301c, by BNS, either automatically, or with a personnel's 301a's intervention. Alternatively, if the office only collects hard copies of the user records, or if it is needed in addition to the soft copy, the form can get printed by BNS and then stored in a file cabinet 301f. It ids noted that if a hard signature is needed it can be collected form the user after the pint out of the filled form 302c.

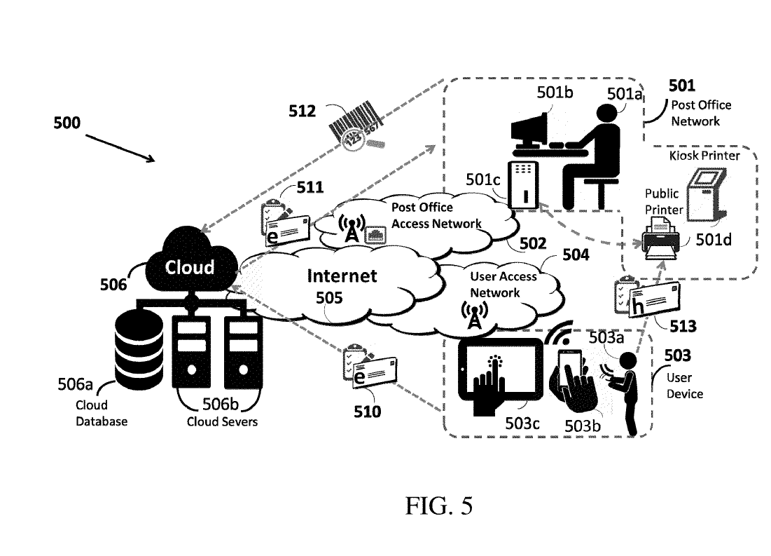

FIG. 5 depicts a networking scenario similar to the FIG. 3 above, but for a different use case, i.e. a postal service, such as USPS, FedEx, UPS, DHL, or other carriers.

Similar to 301, 501 illustrates an example of an office network components and its storage mechanisms, consisting of a monitor 501b, a computer 501c, a printer 501d. However, the printer 501d is located in a public area so that both customers and employees can have access to it. Also unlike FIG. 3, in an embodiment, no data storage is taken place in the mail carrier's office for the service, but rather all the data is uploaded to the cloud for storage (in 506a). 501a shows the office administrative personnel that interacts with BNS for the data transactions required for the postal service.

502 shows the postal service access network which enables connection of the mail carrier local network 501 to the Internet. In an embodiment, the access network may be a wired network that using equipment like switches, routers, gateways and wired media technologies such as Ethernet, Coaxial Cables, MoCA (multimedia over cable) connects the business network to the Internet 505.

In another embodiment, access network may be a wireless network that using equipment like switches, routers, gateways and wireless media technologies like WiFi, or Cellular technologies such as GSM, CDMA, HSPA, WCDMA, LTE or LTE-Advanced connects the business network to the Internet 505.

In yet another embodiment the business access network may constitute a hybrid network made from and arbitrary combination of the wired and wireless network technologies.

503 shows the user's access network which enables connection of the user device 503b, 503c to the Internet. In an embodiment, the access network may be a hotspot network that using equipment like switches, routers, gateways and wireless media technologies like WiFi connects the user device to the Internet 505.

In yet another embodiment the business access network may constitute a hybrid network made from and arbitrary combination of the WiFi and Cellular network technologies.

The cloud 506 is an Internet-based computing platform that provides shared processing resources and data to computers and other devices and is deployed on the Internet as an enabler of ubiquitous, on-demand access to a shared pool of configurable computing resources such as storage, networks, servers, applications and services. The cloud components in FIG. 5 are similar to the ones illustrated in FIG. 3, including a cloud storage device and a database 506a, as well as, a population of the servers that runs and operate the CSS software.

In one embodiment, the cloud database stores all the blank e-forms including address labels for each postal service business that is registered to the mail e-forms and address printing service, and can download them to the user device upon user's request. The set of criteria defining which type of forms and address label formats to use, may be decided by CSS, based on the business's related information such as WLAN SSID, the user location (which can determine the type of business it is currently visiting), or other contextual information that the user device has detected and is communicated through UDS to the CSS. In another embodiment, form filling service may auto-fill the user information such as names and addresses, from an already stored user profile at 505a

The forms and/or address labels 510, constitutes blank e-forms, or forms which are partially or completely filled in the cloud by the form filling service. In this case the service stores the user information required for the form upon registration of the user with the form filling service getting rendered at the cloud.

After the user requests to fill the forms and/or address labels and selection of the appropriate form in the cloud, the forms and/or address labels may be optionally prefilled by the user information from its personal profile in the cloud, and finally is sent and gets downloaded to the user device through interaction between CSS and UDS.

In one embodiment, upon receipt of the e-forms and/or labels, they get further analyzed by the UDS in user device and get partially, or completely filled from the user data stored in the user's local device 303b, 303c.

The e-forms and/or address labels 511 indicate the filled e-forms that are completed on user device, directly by the user or automatically from the user device by UDS, or a combination of the two methods. The cloud then sends the filled forms and/or address labels 512 back to the postal office computer for processing or analysis, and if needed for storage.

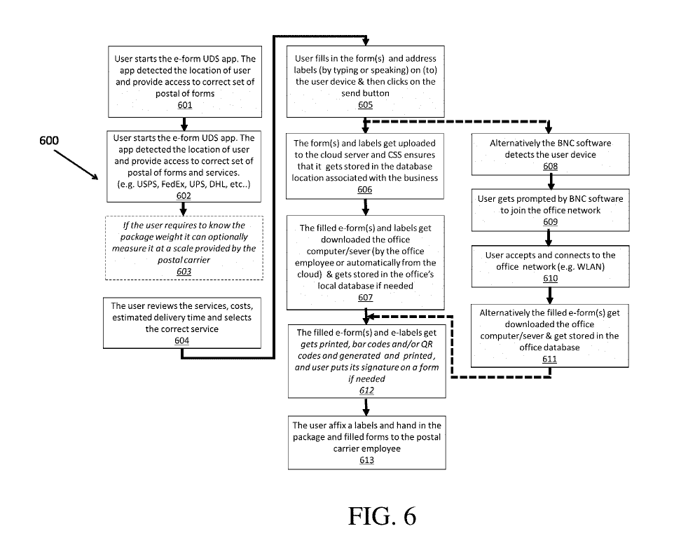

FIG. 6 shows the steps required for the connectivity and data exchange scenario of the FIG. 5. It is noted that the steps described herein may vary according to the type of mail service, user, and network requirements. Accordingly, the steps disclosed are provided to illustrate one example of the disclosed method and apparatus. First, the user starts the e-form application on its mobile device and logs in to the app. In coordination with UDS, the CSS detects the type of applications and address labels that are required for this e-form filling service (601 and 602). In an optional step, if the package weight needs to be measured CSS instruct the user to weight the package (e.g. at a public scale in the office, with or without assistance from the mail carrier personnel, and prompt the user to enter the weight (step 603). The CSS then detects the user device's information and inform the user about the overall cost of shipping.

In an embodiment the user may review the costs and decides whether to continue with printing the forms and labels for the service. If the another service is preferred, the user may decide upon it and the UDS inform the CSS to resend the new forms back to the user device (step 604)

The factor defining which type of user information being fetched in steps 603 and 604, may be decided by the CSS, based on the business's related information such as WLAN SSID, user location (which can determine the type of business it is currently visiting), or other contextual information shared by the business network 501. Additionally, the required personal user information may be fetched from its profile after the form(s) gets downloaded into the user device in step 604.

After the appropriate documents are selected and downloaded the user device, step 605 involves filling and/or auto-filling the forms as discussed in previous examples.

In yet another embodiment, as shown in FIG. 5, all the forms and labels may be preloaded on user device upon installation of the UDS application and the correct form gets fetched at the run time of the app by user instruction. This is more practical due to the limited number of forms in postal services and eliminates the network traffic due to the e-form download from the cloud 506.

It is noted that for any forms that require user signature the signature can be collected electronically, through a confirmation by the user, or by user's finger sketching of its signature on the user's device 503b, 503c. Alternatively, a more secure identity confirmation of the user it its fingerprint, electronically collected by the UDS and incorporated to the filled form 510, though imprinting of the form or a companion finger print file, sent along with 510.

In one embodiment, the e-form then gets uploaded to the cloud and through a component of CSS software running on the server 506b it gets stored in a secure location in the database 506a, if needed.

Using CSS, the filled e-form 512 is then sent to the business network, via Internet and gets downloaded to the business network 501 to be stored in the office local database in needed (410)

In another embodiment, after filling the form on user device, the BNS software can connect the user device to the business network and download the form directly through the local area network of the office. This is shown in FIG. 6 by steps 608, through 611.

In one embodiment in step the filled e-form 511 received from the cloud (or from direct link to the office WLAN), may be be prepared for storage and stored in the business's records. In another embodiment, all storages are performed in the cloud.

In one embodiment in step 612, the cloud office network prepares a print job for the public printer 501d. Then through cloud signaling the user gets informed that the forms and labels are printed

In yet another embodiment in step 612, the user device 503b, 503c includes a print engine, allowing the filled forms and or labels 510 to be directly sent to the public printer or a printing kiosk 501d, though a direct connection between the printer 501d and the user device 503b, 503c.

In one embodiment the direct link between user device 503b, 503c and printer/kiosk 501d can be enabled by wireless technologies like Bluetooth, and WiFi-direct. In this case the filled forms/labels are directly sent to the printer as shown in FIG. 5, 513.

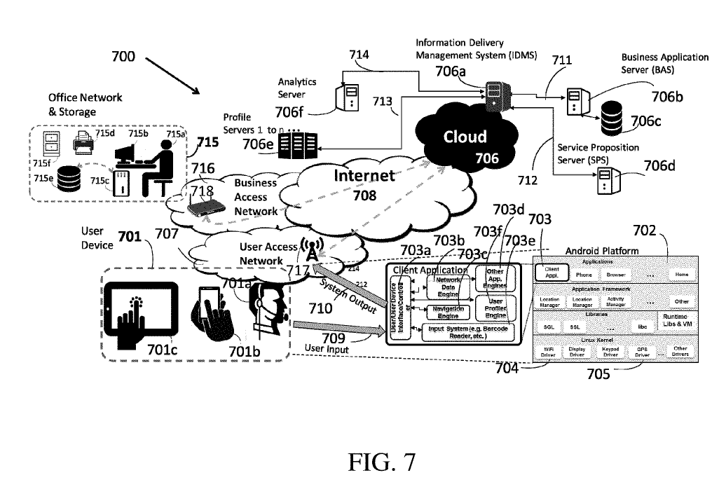

Example of Apparatus Application, an Implementation Scenario: FIG. 7 shows an example scenario for implementing the apparatus and methodologies mentioned above. One goal is to combine the autofill capabilities of the application on user device with a user data input mechanism (e.g. typing on soft keys of its phone or table, or speaking to the phone) to enhance the user experience and save time and effort on both business service provision and user interactions, facilitated through various mechanisms running on cloud application servers. The user experience is enhanced by an automatic and context-aware “e-form selection and download mechanism” along with an “auto-fill process” enabling an “information provision system” that decides on the relevant data such as forms, labels, images, etc. to be downloaded from cloud based on contextual data such as user location, business network ID, etc. and to be partially or fully auto filled based on the user profile and context stored

A) User Device Platform: In the example of a scenario of FIG. 7 the user walks into an office which happens to be on the wireless coverage overlap between the business's WLAN access point (AP) 718 as part of the access network 716 and user's mobile service provider's 4G access network coverage footprint. The latter is an LTE base station (BS) or eNodeB 717, as part of an operator's access network 707, that connects the user to the Internet. Through this access network (707) and user subscription with a carrier, the user is connected to the carrier's core network and the Internet enabling user's communication with the cloud system.

In one embodiment, the business that has subscribed with the e-form data transfer service may be connected to Internet and the cloud servers though a WLAN access point 716 and other devices like switches and gateways (not shown in FIG. 7)

The example of an embodiment of the application software comprises two main components, the server component CSS on the cloud 706 and the client component UDS on the user mobile device 701. The client software component of the apparatus can vary based on the smart phone platform. FIG. 7 illustrates an Android™-based phone as an example of the smart phone, although it will be recognized that other device and types of devices may be readily substituted. In this example, the client program UDS constitutes an Android application 703 running on an Android platform 702 that consists of a series of different components. For more clarity, the Android software stack is shown in FIG. 7, 702, composing of application layer, and a middleware (application framework, libraries, virtual machines) and an operating system based on Linux Kernel. The main usage of the middleware is to simplify building the application. These components may include “Activity,” “Service,” “Content,” etc., and are connected together via the so called “Intent”. The client or UDS App. 703 constitutes a User/User Device Interface/Controller that has different functionalities including loading and running sub-application engines, and reading the user input (i.e. typing or voice converted to a text, by another companion software), as well as the user device input (such as the user data being retrieved for the user device). In this example the user device input may include the user personal information, as well as parameters. Such parameters might include the adjacent WiFi SSID, time stamps and coordinates collected form GPS 705, WiFi 704, and other drivers (latitude, longitude, height, SSID, etc.). In addition, the user device input might include other data that can be collected to enhance the quality of service. Such other data might include discrete events in time and space domains.

In some embodiments, there is also a graphical user interface (GUI) component (not shown) within the UDS or client program. The GUI component is comprised within a User/User Device Interface/Controller 703a. The GUI component is an input system that allows user interaction with the other components of the system. In the example in which the UDS operates using an Android operating system, this is usually an xml file or a java-based component that is considered to be a component of the User/User Device Interface/Controller 703a. The sub-application engines 703b, 703c, 703d 703e, 703f can have different tasks depending on the type of service each provides.

More specifically, in this example we consider a Network Information Engine (NIE) 703b, a Navigation Engine (NE) 703c, an Other App Engine (OAE) 703d, a User Profiler Engine (UPE) 703f, and an input System Engine (ISE) 703e among other possible engines. The Navigation Engine 703c provides the user with real-time location services (RTLS) and can support different applications that can be combined with the network information engine, Input System, and Other Applications Engine.

The accuracy of user location for some applications can be enhanced by using a position location engine, such as an Integrated GPS (Global Positioning System), Assisted GPS, network based location strategies, a processor implementing multi-sensor techniques, and processor using Wireless LAN (WLAN) to determine or assist with determining location. Depending on the user device and its operating system, the position location engine within the user device can merge different positioning technologies to improve the position location determination.

Depending on the software architecture design and supported services, the OAE 703d enables access to other applications that can be used to facilitate service. For example, in some embodiments, APIs provided by Android SDK support Google Maps through a connection to a Google server within the cloud. In some embodiments, the NE module 703c can combine Google Maps with routing software to give directions, as well as Forward and Reverse Geocoding to define the location coordinates at a particular address.

In other embodiments, a cloud printing service such as Google Cloud Printing services may be engaged through OAE 703d. Using such a printing service enables the forms to be printed after being filled. That is, the UDS and CSS enable the Google Cloud to handle the remote printing jobs. In yet another embodiment, third party applications such as Adobe™ Fill can get engaged by OAE, so that the user can directly download PDF forms, convert then to editable version and fill and possibly e-sign them, and from this point on, the forms are handed in to the UDS and CSS control.

The user Profiler Engine processes the user data to produce a distinct profile per user. This profile (or status) is defined by a number of parameters or their combination, such as user's personal information, age, education, current job, health insurance info, complete medical history, addresses of interest, and user status history, such as the forms filled before. Therefore, the user status data or profile can have an initial state that keeps being updated as new changes occur. The initial profile can be stored (e.g. in the user equipment) during the time the user signs up for the service, and it gets updated every time the user status changes. Updates can be event driven (e.g. doctor's office visit, filling new forms, etc.) and on detection of an event the user may get prompted to update the relevant information. This may include user name, address, age, health status, new medications, surgeries, etc. Once the user status data is updated it can also be uploaded to the cloud for cloud profile update.

Finally, the Input System Engine (ISE) 703e is responsible for gathering the input data that is read by, typed in and captured by the user device such as the inputted data for a form, pictures, medical images (X-rays, MRIs, etc.,) video (e.g. on occurrence of an accident or injury), barcode data, Quick Response or QR data [3], (a two dimensional bar code system proposed by ISO standards) which is translated by a reader to specific data for specific applications. In the latter case a Barcode or QR reader application can be used by the OAE. Alternatively, the ISE transforms the barcode or QR data read by the smart phone's camera to the relevant information corresponding to the service of interest.

B) Cloud Platform: On the cloud side of the software platform, the CSS is composed of a series of different applications that can run over multiple servers as described below (e.g. SPS, BAS, IMDS, etc.). Users can benefit from a context aware or status aware information provision system that matches the “user profile” data, and other context like location, time of day, etc. to a service that can be recommended by service proposition server (SPS) 706d. In FIG. 7, the program in SPS 706d receives the user profile data through the LTE network connected to the Internet network and send profile updates to the appropriate user profile server 706e, responsible for the user.

More specifically, the user device 701 is connected to the 4G (LTE) BS (or eNodeB) 717 via the link 710. The base station in turn is connected to the 4G core network and the Internet 708. On the other side of this connection, the SPS 706d receives the relevant contexts associated with current user profile data output and his/her status by the user profiler engine 703f located in the application 703 running on the user device 701b, 701c.

Upon receipt of this information and in association with its available database, the SPS 308 recommends a certain type of information transfer such as “form filling services” (e.g. post office forms, UPS forms, FedEx forms, an eye specialist form, a GP first time visitor form, a law office agreement, etc.) from the business directory-based data on a database 706c associated with the business application server or BAS 706b. Once a specific data such as “form fill-in service profile” is identified for the user, the appropriate blank e-forms, labels, etc., are fetched form the BAS database 706c and sent to the user device.

In another embodiment, if a cloud-based user personal profile exists in the profile servers 706e, an autofill application is activated to detect, filter, and fetch the user's personal data and using a portion of CSS responsible for auto-fill can prefill the form with the relevant profile information, before delivery to the user device.

The autofill service may be also implemented as a plugin for the CSS software. Adding an autofill plugin to the e-form can also allow user to check a box to auto-fill another field on the e-form with data entered in the first field. For example, if on a form requires collecting both a Shipping and a Billing address, the user could enter their Shipping address and click the Auto-Fill option to automatically populate the Billing Address Fields with the same data.

Cloud user profiles are run on “n” specific profile servers 1 to n 706e identified and updated based on the received user profile data through SPS. Using access to profile servers and the SPS 706d, the Information Delivery Management System (IDMS) 706a decides on the appropriate business forms, fetches them from BAS database and prefills them as much as it can, and then transfers them back to the user device 701b, 701c. For example, if the user device data indicates that he/she is in a FedEx office, upon user conforming the use of e-form services, the BAS responsible for provision of FedEx forms is inquired by the IDMS and if needed the form gets prefill with the user information and address though access to profile servers 706e.

Once the form is fetched and processed, e-form (the bank or prefilled) will be send back to the user for further filling, signature collection and or other actions such as printing (e.g. through direct connection of the user device to a public printing Kiosk, as shown in FIG. 5.).

In one embodiment, upon completion of the form by user and/or user device, the e-form is sent back to the cloud for delivery to the business network, for storage, printing, etc. This can be done via e.g., the IDMS 706a connection to the Internet 708 and the business gateway and WLAN network 716.

Note that the user profiler engine in the UDS 703f, can interact with user profile server on 706e to update profile information or facilitate specific queries by the user. For example, upon completion of the e-form by the user and sending the form back to the cloud, the IDMS 706a may compare the filled information with the existing information in the content servers 706e and if there is any change, it may update the user profile in the cloud.

Also, during completion of a form, the user may have forgotten about certain dates, numbers, and other form related information. In this case, if this information is not locally stored in user's device, as part of UDS 703, the user may make queries to his/her profile server in cloud (706e) which can provide the user with the requested information. In this regards user profiler engine 703f may also collect this information and add it to the user profile inside the user device 701b, 701c for future auto-fills, etc. This is particularly useful if the user has more than one device, so that all of the user devices and cloud can be updated with the most recent user data.

In one embodiment the e-form/label filling services create a user profile for autofill purposes. This profile is a data structure that can be stored in user device using the user profiler service 703f, in the cloud, on one of the profile servers of 706e, or in both locations. This profile is created upon registration and based on consequent interactions with the system, which is a per user profile data structure. This user profile data may include user's full name, phone numbers, user's personal address and its addresses of interest e.g. from form filling or mailing history), health history, pictures, medical images, etc.

The example of a structure of FIG. 7 can also be a useful tool for various social networking applications. For example, users can provide a feedback on their overall satisfaction with the business service based on a MOS (mean opinion score), and/or in response to a survey sent to them by the business (e.g. using CSS). Using the data transfer structure of FIG. 7, this information can be incorporated to the user profile, transferred to profile servers, and can also be anonymously sent back to the business though BAS 706b and IMDS 706a.

In another aspect of the disclosed method and apparatus, the architecture of FIG. 7 can be used to enhance the operation of a business and/or user experience while being served at the local business. This includes the user experience with the e-form service, as well as, other aspects of the business such as wait time, the nurse and doctor's services, seating spaces, etc.

In an aspect of this disclosed method and apparatus, the data in various user profiles can be used in an analytic engine running on the analysis server 706f. In one embodiment, anonymous user information can be used by businesses for statistical purposes. For example, a doctor's office can gather data about the distribution of their patient ages, diseases, insurance carrier, user experience etc. These analytics can be used for many purposes such as enhancing the customer service, enhancing the business processes, medical studies, patient referrals, etc. resulting in better services, profitability, and user experience.

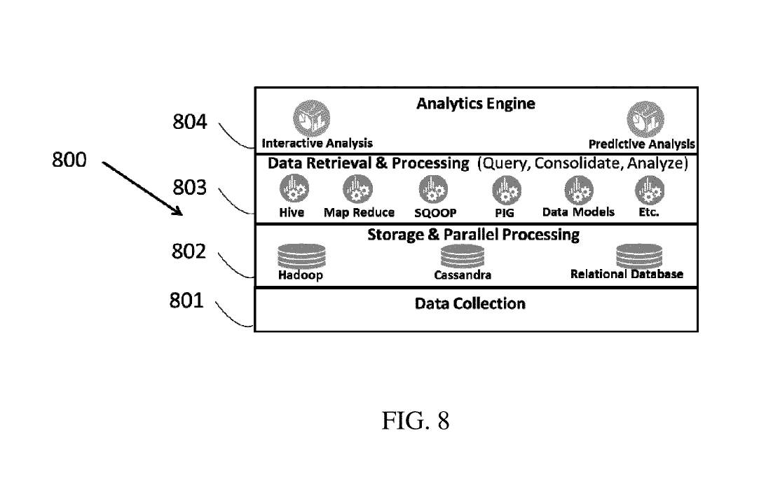

FIG. 8 shows an example of an architecture for the analytics engine and its software components, running on the analytics server(s) 706.f. In some embodiments components of the software platforms mentioned herein may be distributed through other servers such as profile server 706e, as opposed to all being populate in analytics server 706f.

Data collection: As shown in FIG. 8, the first step is a scalable “Data Collection” 801. This step allows various businesses, such as health service providers, mail carriers, law offices, etc. to collect and store anonymous or specific user any data, as often as they need. This data can be collected from the Profile Servers 706e, in coordination with the Information Delivery Management System (IMDS) 706a. This data may also be collected from logs, CSV files, etc.

Storage and parallel processing: This layer 802 may include massive parallel processing and storage platforms such as HADOOP for big data storage and batch processing, CASSANDRA for real-time data analytics (for example, for real-time customer support), and relational database for data storage for reports and dashboard tools.

Data retrieval and processing: Layer 803 is built on top of layer 802 (e.g. HADOOP), and is used for data querying and analysis—using data processing frameworks and tools, such as HIVE, MapReduce, and SQOOP.

Analytics engine and business intelligence: This layer 804, is in charge of consolidation, correlation, and analysis of data for automated actions or human interpretation. This includes filtering and normalization of raw data, and mapping of the data to particular KPIs and use case templates.

Domain-specific analytics solutions: This layer 805 allows users and businesses to organize the resulting analytics events and alerts into particular business needs, such as patient health history and risk analysis, user demographic analytics, customer survey statistical analysis, etc.

While the above detailed description has shown, described, and pointed out novel features of the disclosed method and apparatus as applied to various embodiments, it will be understood that various omissions, substitutions, and changes in the form and details of the device or process illustrated may be made by those skilled in the art without departing from the claimed invention. This description is in no way meant to limit the claimed invention, but rather should be taken as illustrative of the general principles of the disclosed method and apparatus. Thus, the scope of the claimed invention should be determined only with reference to the claims.

What is claimed is:

1. A user device comprising:
a) wireless interface for communicating over a network;
b) a user interface for receiving input from a user; and
c) a processor for;
i. receiving a request over the network for information to be sent from the user device over the network in a form;
ii. retrieving information to be sent in the form; and
iii. providing the retrieved information in the form to the wireless interface to be sent to over the network.

2. The user device of claim 1, wherein the network is an enterprise network.

3. The user device of claim 1, wherein the network is a cellular network.

4. The user device of claim 1, wherein the network is connected to a cloud database.

5. The user device of claim 1, wherein the network is a combination of an enterprise network and a cellular network, at least one of which is connected to a cloud server.

6. The user device of claim 1, wherein the user device receives the request from the network in response to the user device being in range to receive signals from the network.

7. The user device of claim 1, further including a barcode reader.

8. The user device of claim 1, further including a position location engine.

9. The user device of claim 1, further including a print engine coupled to the processor to allow the form to be printed at a printer remote from the user device.

10. The user device of claim 1, wherein the request from the network further includes a form for providing the requested information.

11. The user device of claim 1, wherein the requested information relates to a medical patient.

12. The user device of claim 11, wherein the included medical patient is a user of the user device.

13. The user device of claim 1, wherein the included form provides information regarding a medical history of a medical patient.

14. The user device of claim 1, wherein the included form provides personal information about a medical patient.

15. The user device of claim 1, wherein the requested information relates to a postal service.

16. The user device of claim 15, wherein the requested information includes an address to which a postal delivery is to be delivered and a return address for the postal delivery.

17. The user device of claim 1, wherein the processor is further for receiving User Device Software from the network.
